(19) United States
(12) Patent Application Publication
(10) Pub. No.: US 2026/0116525 A1
(43) Pub. Date: Apr. 30, 2026

(54) AIRCRAFT WING ASSEMBLY

(71) Applicant: Airbus Operations Limited, Bristol (GB)

(72) Inventors: Ian BEVIS, Bristol (GB); Paul MORRELL, Bristol (GB)

(21) Appl. No.: 19/306,483

(22) Filed: Aug. 21, 2025

(30) Foreign Application Priority Data
Oct. 30, 2024 (GB) 2415996.4

(51) Int. Cl. B64C 3/56; B64C 23/06

(52) U.S. Cl. CPC B64C 3/56; B64C 23/072

(57) ABSTRACT

An aircraft wing assembly (31) is disclosed. The aircraft wing assembly (31) comprises a wing tip device (11) rotatable about a hinge axis (H) between a flight configuration and a ground configuration and a wing tip device actuation system (20) comprising a bell crank (21) and a linear actuator (23). The bell crank (21) is rotatably mounted to the aircraft wing assembly (31) and is rotatable about a bell crank axis (C) which is offset from the hinge axis (H). The linear actuator (23) is operable to rotate the bell crank (21) about the bell crank axis (C) to thereby move the wing tip device (11) about the hinge axis (H), between the flight configuration and the ground configuration.

### BACKGROUND OF THE INVENTION

The present invention concerns an aircraft wing assembly comprising a wing tip device configurable between a flight configuration and a ground configuration. More particularly, but not exclusively, this invention concerns an aircraft wing assembly comprising bell crank or a lever and a linear actuator operable to rotate the bell crank or lever to move the wing tip device between the flight configuration and the ground configuration. The present invention also concerns a method of operating the aircraft wing assembly, an aircraft wing comprising the aircraft wing assembly, and an aircraft comprising said aircraft wing.

There is a trend towards increasingly higher aspect ratio wings for large passenger aircraft, for which it is desirable to have correspondingly large wing spans. However, the maximum aircraft span is effectively limited by airport operating rules which govern various clearances required when manoeuvring around the airport (such as the span and/or ground clearance required for gate entry and taxiway usage).

Movable wing tip devices have therefore been introduced into passenger aircraft whereby a wing tip device is movable between a flight configuration for use during flight and a ground configuration for use during ground-based operations. In the flight configuration, the wing tip device forms an extension of the wing and contributes to the lift generated by the wing. In the ground configuration, the wing tip device is moved away from the flight configuration such that the effective span of the aircraft wing is reduced, thereby allowing use of existing gates and taxiways. Such an arrangement is sometimes referred to as a ‘folding wing tip’.

An aircraft wing comprising a movable wing tip device requires an actuation system to effect movement of the moveable wing tip device between the flight configuration and the ground configuration. However, there is limited space available within the wing for such actuation systems.

Aspects of the present invention seek to mitigate one or more of the above-mentioned challenges. Alternatively or additionally, aspects of the present invention seek to provide an improved aircraft wing assembly and improved apparatus and methods relating thereto.

### SUMMARY OF THE INVENTION

According to a first aspect, the present invention provides an aircraft wing assembly, the aircraft wing assembly comprising a fixed wing and a wing tip device at the tip thereof, wherein the wing tip device is configurable between: (i) a flight configuration for use during flight and (ii) a ground configuration for use during ground-based operations, in which ground configuration the wing tip device is rotated away from the flight configuration about a hinge axis such that the span of the aircraft wing assembly is reduced, wherein: the aircraft wing assembly further comprises a wing tip device actuation system comprising a bell crank and a first linear actuator; the bell crank is rotatably mounted to one of the fixed wing or wing tip device at a pivot point of the bell crank and is rotatable about a bell crank axis defined by the pivot point, the bell crank axis being offset from the hinge axis, the bell crank is connected to the one of the fixed wing or the wing tip device on a first side of the pivot point by a linear actuator; the bell crank is connected to the other one of the fixed wing or wing tip device on an opposite second side of the pivot point; and the first linear actuator is operable to rotate the bell crank about the bell crank axis to thereby move the wing tip device about the hinge axis, between the flight configuration and the ground configuration.

The first linear actuator may comprise any suitable linear actuator. For example, the first linear actuator may comprise a linear hydraulic actuator, a roller screw actuator, or a ball screw actuator. The first linear actuator may be oriented in a direction which is perpendicular to a streamwise direction of the wing, the streamwise direction being parallel with the incident airflow when the aircraft wing is moving in a flight direction. The first linear actuator may be oriented in a spanwise direction of the wing (the spanwise direction of the wing may be perpendicular to a fuselage of an aircraft upon which the aircraft wing assembly is to be installed) such that the first linear actuator is arranged to extend in a generally spanwise direction of the wing. The hinge axis may be parallel to the streamwise direction of the wing. Arranging the wingtip device to fold about an axis which is parallel to the streamwise direction of the wing may be advantageous where the wing tip device is to be moved between the flight configuration and ground configuration while the aircraft is taxiing because this may mitigate any increase in drag caused by the wing tip device when not in the flight configuration. The hinge axis may be parallel to a chordwise direction of the wing. The bell crank axis may be parallel to the hinge axis. The bell crank may be constrained against significant movement along the bell crank axis. The bell crank may not be movable along the bell crank axis. The bell crank may also be referred to herein as a pair of lever arms.

The aircraft wing assembly of the first aspect of the invention has an actuation system in which the actuation force provided by a linear actuator is transferred around an axis (i.e. the bell crank axis) which is spaced apart from the hinge axis of the wing. By spacing the bell crank axis apart from the hinge axis, the actuation system may make more efficient use of the limited space available within the wing when compared, for example, to a similar arrangement wherein the bell crank axis is coincident with the hinge axis. Furthermore, the position of the bell crank axis may be optimised to match the mechanical advantage with the peak loads experienced due to the wing tip device form, mass, and/or external factors such as, for example, gusts.

The bell crank axis may be offset from the hinge axis along a first direction perpendicular to the hinge axis. The bell crank axis may be spaced apart from the wing hinge axis by at least about 2 centimetres in the first direction. The bell crank axis may be spaced apart from the wing hinge axis by at least about 3 centimetres in the first direction. The bell crank axis may be spaced apart from the wing hinge axis by at least about 5 centimetres in the first direction. The bell crank axis may be spaced apart from the wing hinge axis by up to about 20 centimetres in the first direction. The bell crank axis may be spaced apart from the wing hinge axis by up to about 25 centimetres in the first direction. The bell crank axis may be spaced apart from the wing hinge axis by up to about 30 centimetres in the first direction.

The bell crank axis may be offset from the hinge axis along a second direction, the second direction being perpendicular to the hinge axis and to the first direction. The bell crank axis may be spaced apart from the wing hinge axis by at least about 2 centimetres in the second direction. The bell crank axis may be spaced apart from the wing hinge axis by at least about 3 centimetres in the second direction. The bell crank axis may be spaced apart from the wing hinge axis by at least about 5 centimetres in the second direction. The bell crank axis may be spaced apart from the wing hinge axis by up to about 20 centimetres in the second direction. The bell crank axis may be spaced apart from the wing hinge axis by up to about 25 centimetres in the second direction. The bell crank axis may be spaced apart from the wing hinge axis by up to about 30 centimetres in the second direction. The bell crank axis may be spaced apart from the hinge axis along a spanwise direction of the aircraft wing assembly. Alternatively or additionally, the bell crank axis may be spaced apart from the hinge axis along a thickness direction of the aircraft wing assembly. The thickness direction may be measured between opposing upper and lower skins of the wing. The bell crank axis may be positioned between opposing upper and lower skins of the aircraft wing assembly. The bell crank axis may be positioned between opposing upper and lower skins of the aircraft wing assembly. The hinge axis may be positioned between opposing upper and lower skins of the aircraft wing assembly.

The bell crank may comprise a first arm on a first side of the bell crank and a second arm on an opposite second side of the bell crank. The first and second arms may extend from a section of the bell crank that provides the pivot point. The first arm and second arm may be spaced apart by an angle of between approximately 30 degrees and 180 degrees, measured from the pivot point. The first arm and second arm may be spaced apart by an angle of between approximately 45 degrees and 130 degrees, measured from the pivot point. The bell crank may have a generally “V”-shaped profile.

The first linear actuator may comprise two linear actuators arranged in parallel. The first linear actuator may be connected to the bell crank at a first end and to a rib of the aircraft wing assembly at an opposite second end. Alternatively or additionally, the first linear actuator may be connected to the bell crank at a first end and to a spar, a stringer and/or a wing skin of the aircraft wing assembly at an opposite second end. The first end of the linear actuator may be provided by a cylinder of the linear actuator and the second end may be provided by a piston or vice versa.

The wing tip device actuation system may further comprise a second linear actuator. The second linear actuator may comprise any of the features described in relation to the first linear actuator. The bell crank may be connected to the other one of the fixed wing or wing tip device by the second linear actuator. The second linear actuator may be operable to impose a relative displacement between the bell crank and the other one of the fixed wing or wing tip device to thereby move the wing tip device between the flight configuration and the ground configuration. Using a first linear actuator and a second linear actuator in this manner may provide the advantage of being able to effect a larger rotation of the wing tip device relative to the fixed wing than where a single linear actuator is used if, for example, the second linear actuator has the same stroke as the first linear actuator. Alternatively, the use of a first and second linear actuator in this manner may permit the two smaller linear actuators to be used to effect the same rotation of the wing tip device as an arrangement comprising a single larger linear actuator.

The wing tip device actuation system may further comprise a pushrod. A pushrod may comprise an elongate rod. The bell crank may be connected to the other one of the fixed wing or wing tip device by the pushrod. The pushrod may comprise two or more pushrods connected in parallel. The use of a pushrod may enable the actuation force provided by the first linear actuator to be introduced into the other one of the fixed wing or wing tip device at a particularly desirable location.

The bell crank may be rotatably mounted to the one of the fixed wing or wing tip device at the pivot point of the bell crank via a male-female connector. The male-female connector may have sufficient play to allow translation of the bell crank in a direction perpendicular to the bell crank axis to accommodate bending of the aircraft wing assembly during movement of the wing tip device between the flight configuration and the ground configuration. The female part of the connector may be dimensioned with respect to the male part to permit translation of the bell crank by up to ±4 millimetres or by up to ±2 millimetres in a direction perpendicular to the bell crank axis during movement of the wing tip device between the flight configuration and the ground configuration. The female part of the connector may be dimensioned with respect to the male part to permit translation of the bell crank in a direction perpendicular to the bell crank axis by up to ±1 millimetres during movement of the wing tip device between the flight configuration and the ground configuration. The bell crank may be permitted to translate in a radial direction with respect to the bell crank axis.

The male-female connector may comprise a pin which is rotatably mounted within a hole. The hole may be provided in the bell crank. The pin may form part of the fixed wing or wing tip device. The hole may be provided by the fixed wing or wing tip device. The pin may form part of the bell crank. The pin may have a circular cross-section. The hole may be dimensioned with respect to the pin to permit translation of the pin within the hole in a direction perpendicular to the bell crank axis by up to ±4 millimetres, ±2 millimetres, or ±1 millimetres, such that the bell crank is able to translate relative to the one of the fixed wing or wing tip device during movement of the wing tip device between the flight configuration and the ground configuration.

Bending of the wing caused by, for example, the aerodynamic loads on the wing being reduced as the aircraft lands or by the aerodynamic or structural loads on the wing changing as the wing tip device is moved towards the ground configuration may introduce undesirable loads into the actuation system. Dimensioning the hole such that it is larger than the pin reduces the constraint placed on the bell crank during movement of the wing tip device between the flight configuration and the ground configuration, thereby allowing the bell crank to translate by a limited degree in response to such undesirable loads, which may mitigate undesirable stress concentrations being introduced into the actuation system. For example, such an arrangement may reduce the loads transmitted into the actuator(s) during flight, which may increase the service life of the actuator(s).

The fixed wing may have an upper surface and a lower surface (or an upper wing skin and a lower wing skin). The wing tip device may have an upper surface and a lower surface (or an upper wing skin and a lower wing skin). In the flight configuration, the upper and lower surfaces of the wing tip device may be continuations of the upper and lower surfaces of the fixed wing. In the flight configuration, the trailing edge of the wing tip device may be a continuation of the trailing edge of the fixed wing. The leading edge of the wing tip device may be a continuation of the leading edge of the fixed wing. It may be that there is a smooth transition from the fixed wing to the wing tip device. It will be appreciated that there may be a smooth transition even when the shape of the wing is such that there are changes in sweep or twist at the junction between the fixed wing and wing tip device. It may be that there are no discontinuities at the junction between the fixed wing and wing tip device.

In the flight configuration, the span of the wing may exceed an airport compatibility limit. In the ground configuration the span is reduced such that the span (with the wing tip device in the ground configuration) is less than, or substantially equal to, the airport compatibility limit. The airport compatibility limit is preferably a span limit (for example relating to clearance restrictions for buildings, signs, other aircraft). The compatibility limit is preferably a gate limit. In the ground configuration, the wing tip device may be positioned such that the wing has its shortest span. In the ground configuration, the wing tip device may be oriented substantially vertical.

The wing tip device may be a wing tip extension, for example a generally planar tip extension. In other embodiments, the wing tip device may comprise, or consist of, a non-planar device, such as a winglet. The wing tip device may comprise a further wing section having a further movable wing tip device at its distal end. The ordinarily skilled person will be aware of other devices suitable for movably placing at the wing tip. The wing tip device may include, for example, trailing edge moveable devices for control (ailerons) or leading edge devices for stall protection, such as slats or droop nose devices. It will be appreciated that the term ‘wing tip device’ does not limit the size of that structure. For example, the wing tip device may be a large wing extension, and may equally be considered a secondary, or outboard, wing. The length of the wing tip device may be more than 3 m, preferably more than 4 m, and more preferably more than 5 m.

The span ratio of the fixed wing relative to the wing tip device may be such that the fixed wing comprises at least 60%, 70%, 80%, 90%, or more, of the overall span of the wing.

When the wing tip device is in the ground configuration, the aircraft may be unsuitable for flight. For example, the wing tip device may be aerodynamically and/or structurally unsuitable for flight in the ground configuration. The aircraft is preferably configured such that, during flight, the wing tip device is not moveable to the ground configuration. The aircraft may comprise a sensor for sensing when the aircraft is in flight. When the sensor senses that the aircraft is in flight, a control system is preferably arranged to disable the possibility of moving the wing tip device to the ground configuration. In the ground configuration the wing tip device may be held in place. For example, the wing tip device may be latched or locked in place to prevent movement back towards the flight configuration.

According to a second aspect, the present invention provides an aircraft wing assembly comprising a fixed wing, a wing tip device at the tip of the fixed wing, a pair of lever arms, and a linear actuator, wherein: the wing tip device is movable with respect to the fixed wing between: (i) a flight configuration for use during flight and (ii) a ground configuration in which the wing tip device is rotated away from the flight configuration about a hinge axis such that the span of the aircraft wing assembly is reduced, wherein: the pair of lever arms is pivotally mounted to the aircraft wing assembly at a pivot point of the pair of lever arms, the pair of lever arms being pivotable about a lever axis which is spaced apart from the hinge axis; the linear actuator is connected between a first arm of the pair of lever arms and one of the fixed wing or wing tip device; a second arm of the pair of lever arms is connected to the other one of the fixed wing or the wing tip device, the pivot point of the pair of lever arms being between the first arm and the second arm; and the linear actuator is configured to displace the first arm of the pair of lever arms relative to the one of the fixed wing or wing tip device to move the wing tip device between the flight configuration and the ground configuration.

According to a third aspect, the present invention provides an aircraft wing comprising an aircraft wing assembly according to the first or second aspects of the invention.

According to a fourth aspect, the present invention provides an aircraft comprising an aircraft wing according to the third aspect of the invention. The aircraft may of course have a second wing according to the first or second aspects of the invention. The aircraft may comprise a control system for operating the first linear actuator (and any additional linear actuators) for moving the wing tip device between the ground flight configuration and the ground configuration.

The aircraft may be a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and optionally more than 75 passengers. The aircraft may be a commercial aircraft, for example a commercial passenger aircraft, for example a single aisle or twin aisle aircraft. The aircraft need not be configured for carrying passengers but could for example be an aircraft of an equivalent size configured for cargo and/or used on a non-commercial basis. The aircraft may have a maximum take-off weight (MTOW) of at least 20 tonnes, optionally at least 40 tonnes, and possibly 50 tonnes or more. The aircraft may have an operating empty weight of at least 20 tonnes, optionally at least 30 tonnes, and possibly about 40 tonnes or more.

According to a fifth aspect, the present invention provides a method of moving a wing tip device of an aircraft wing assembly between a flight configuration and a ground configuration. The aircraft wing assembly may be an aircraft wing assembly according to the first aspect of the invention. The method may comprise the step of operating the first linear actuator to rotate the bell crank about the bell crank axis. The method may comprise the step of operating a second linear actuator to displace the other one of the fixed wing or wing tip device with respect to the bell crank. The method may comprise moving the wing tip device towards the ground configuration. The method may comprise moving the wing tip device towards the flight configuration. The first linear actuator and second linear actuator may be operated simultaneously. Alternatively, the first linear actuator and the second linear actuator may be operated in sequence. For example, in a first step, one of the first or second linear actuators may be operated to move the wing tip device from the flight configuration or the ground configuration to an intermediate configuration. In a later second step, the other of the first or second linear actuators may be operated to move the wing tip device from the intermediate configuration to the ground configuration or flight configuration.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present disclosure will now be described by way of example only with reference to the accompanying schematic drawings of which:

FIGS. 1A and 1B show a plan view and a frontal view respectively, of an aircraft according to a first embodiment of the invention;

FIG. 2A is a schematic cross-sectional view of a wing assembly of the aircraft which shows the configuration of the fixed wing, wing tip device, and wing tip device actuation system when the wing tip device is in the flight configuration;

FIG. 2B corresponds to the arrangement shown in FIG. 2A but shows the configuration of the fixed wing, wing tip device, and wing tip device actuation system when the wing tip device is in between the flight configuration and the ground configuration;

FIG. 2C corresponds to a plan view of the arrangement shown in FIG. 2A;

FIG. 3 shows the bell crank of the wing tip device actuation system;

FIG. 4A is a schematic cross-sectional view of an aircraft wing assembly according to a second embodiment of the invention which shows the configuration of the fixed wing, wing tip device, and wing tip device actuation system when the wing tip device is in the flight configuration;

FIG. 4B corresponds to the arrangement shown in FIG. 4A but shows the configuration of the fixed wing, wing tip device, and wing tip device actuation system when the wing tip device is in between the flight configuration and the ground configuration;

FIG. 4C corresponds to a plan view of the arrangement shown in FIG. 4A; and

FIG. 5 is a schematic plan view of an aircraft wing assembly according to a third embodiment of the invention which shows the configuration of the fixed wing, wing tip device, and wing tip device actuation system when the wing tip device is in the flight configuration.

### DETAILED DESCRIPTION

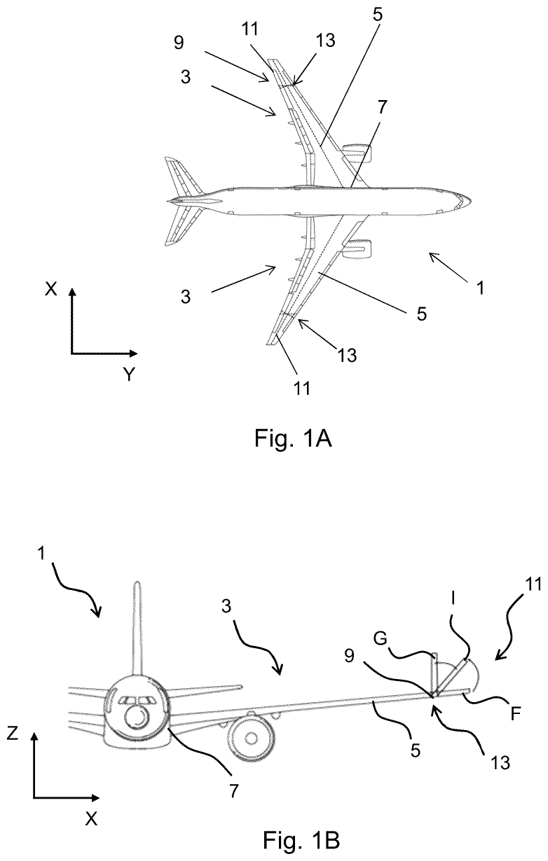

FIGS. 1A and 1B show a plan view and a front view of an aircraft 1 according to a first embodiment of the invention. The aircraft 1 comprises two wings 3 extending outwardly from a fuselage in a spanwise direction X which is perpendicular to a longitudinal direction Y (only one wing is fully visible in FIG. 1B). Each wing 3 comprises a fixed wing 5 extending from a root 7 to a tip 9. At the tip 9 of the fixed wing 5, the wing 3 also comprises a moveable wing tip device 11. In this embodiment, the wing tip device 11 comprises a planar wing tip extension. The wing tip device 11 is rotatably mounted on a hinge joint 13, having a hinge axis H. As such, the wing tip device 11 is able to rotate about the hinge joint 13 relative to the fixed wing 5.

Referring to FIG. 1B, the wing tip device 11 is rotatable about the hinge joint 13 between a flight configuration F and a ground configuration G. FIG. 1B also shows the wing tip device 11 in an intermediate configuration I, part-way between the flight configuration and the ground configuration.

In the flight configuration F, the wing tip device 11 is an extension of the fixed wing 5. Accordingly, the upper and lower surfaces of the fixed wing 5 are continuous with the upper and lower surfaces of the wing tip device 11. The leading and trailing edges of the fixed wing 5 are also continuous with the respective leading and trailing edges of the wing tip device 11.

In the ground configuration G, the wing tip device 11 is oriented in a substantially upright position such that the effective span of the wing 3 is reduced. The movable wing tip device 11 therefore enables the aircraft 1 to have a relatively large wingspan during flight and to comply with airport gate limits when on the ground.

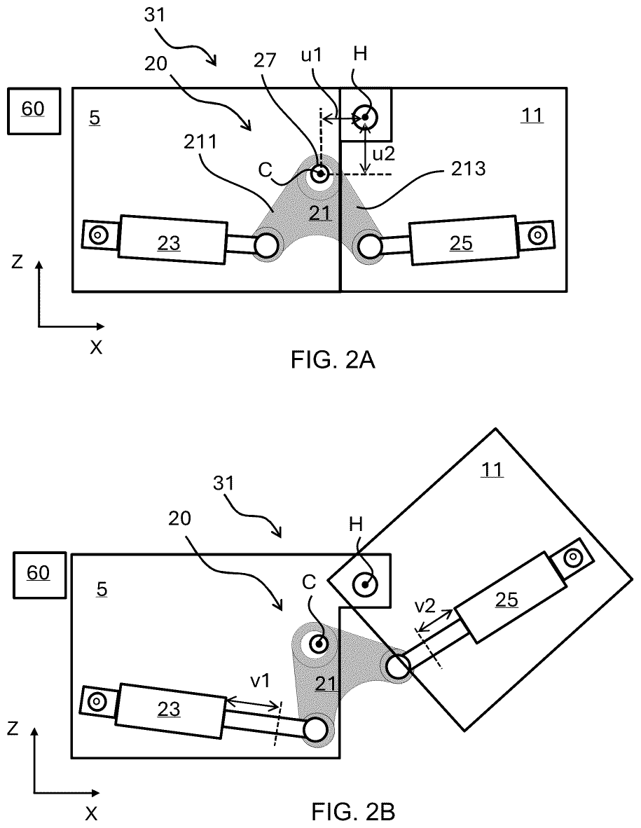

The wing tip device 11 is moved between the ground configuration and the flight configuration by an actuation system 20. The actuation system is shown schematically in FIGS. 2A-2C, which show an aircraft wing assembly 31 that forms part of the aircraft wing 3. The actuation system comprises a bell crank 21, an inboard linear actuator 23, and an outboard linear actuator 25.

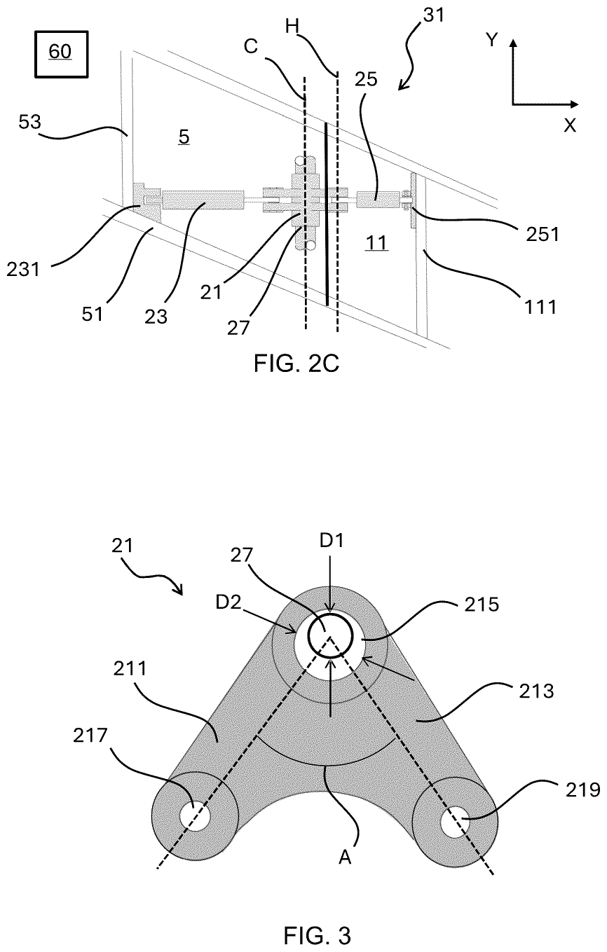

With reference to FIG. 3, the bell crank 21 comprises a first arm 211 on a first side of the bell crank 21 and a second arm 213 on an opposite second side of the bell crank 21 (the first arm 211 and second arm 213 may be referred to herein as lever arms). The first and second arms 211, 213 extend from a section of the bell crank 21 provided with a fulcrum hole 215. The fulcrum hole 215 provides a pivot point of the bell crank 21. The first arm 211 and second arm 213 of the bell crank 21 are spaced apart by an angle A, of approximately 70 degrees, measured from the centre of the hole 215, to provide the bell crank 21 with a generally “V” shaped profile. In other embodiments of the invention the angle A may be between 45 degrees and 130 degrees. A hole 217 is provided at the distal end of the first arm 211 and a hole 219 is provided at the distal end of the second arm 213.

The bell crank 21 is rotatably mounted upon a crank pin 27 which passes through the fulcrum hole 215 of the bell crank 21, the crank pin 27 and fulcrum hole 215 thereby forming a male-female connector. The crank pin 27 is fixedly mounted to the fixed wing 5 to provide a fixed point of rotation upon the fixed wing 5. As can be best seen in FIG. 3, the diameter D1 of the crank pin 27 is less than the diameter D1 of the fulcrum hole 215. The bell crank 21 is therefore rotatable about the crank pin 27, which defines a crank axis C. A particular feature of the invention is that the crank axis C is offset from the hinge axis H. As can be seen in FIG. 2A, the crank axis C is spaced apart from the hinge axis H by a distance u1 in the spanwise direction X of the wing assembly 31 and by a distance u2 in the thickness direction Z of the wing assembly 31. Spacing the crank axis C away from the hinge axis H provides more design freedom and enables the actuation system to make more efficient use of the limited space available within the wing assembly 31 when compared, for example, to a similar arrangement wherein the bell crank axis is restricted to being coincident with the hinge axis H. As can be seen in FIG. 2C both the hinge axis H and crank axis C are oriented parallel with one another and parallel with the longitudinal direction Y, which corresponds to the freestream direction of the wing. However, in other embodiments of the invention, the hinge axis and crank axis may not be parallel with one another or with the freestream direction.

The bell crank 21 is also able to translate to a limited degree with respect to the crank pin 27 (and crank axis C) due to the over-sized fulcrum hole 215 providing space in which the crank pin 27 can move relative to the bell crank 21. In the present embodiment of the invention, the difference between diameter D2 and the diameter D1 is approximately 2 millimetres, which permits the bell crank 21 to be translated by ±1 millimetre in a radial direction with respect to the crank axis (as such, the bell crank can be moved by ±1 millimetre in a spanwise direction X of the wing assembly 31 and by ±1 millimetre in a thickness direction Z of the wing assembly 31, the thickness direction Z being perpendicular to the spanwise direction X). In other embodiments of the invention, the bell crank may be permitted to translate by a greater amount.

The inboard linear actuator 23 is connected between the hole 217 provided in the first arm 211 of the bell crank 21 and the fixed wing 5. The outboard linear actuator 25 is connected between the hole 219 provided in the second arm 213 of the bell crank 21 and the wing tip device 11. As can be best seen in FIG. 2C, the inboard linear actuator 23 and outboard linear actuator 25 are arranged to extend in a generally spanwise direction X of the wing 3. The inboard linear actuator 23 is mounted to the fixed wing 5 via a fitting 231 which is mounted to the rear spar 51 and to a rib 53 of the fixed wing 5. In embodiments of the invention the fitting could be mounted to one of the spar or the rib. The outboard linear actuator 25 is mounted to the wing tip device 11 via a fitting 251 which is mounted to a rib 111 of the wing tip device 11. In embodiments of the invention, either fitting 231, 251 could be alternatively or additionally mounted to the cover.

In order to move the wing tip device 11 from the flight configuration F to the ground configuration G the inboard linear actuator 23 and the outboard linear actuator 25 are operated using a control system 60 of the aircraft 1. With reference to FIG. 2B, the inboard linear actuator 23 is operated to displace the distal end of the first arm 211 of the bell crank 21 by a distance v1, which causes the bell crank 21 to rotate about the bell crank axis C and which thereby causes the wing tip device 11 to rotate away from the flight configuration F. Similarly, the outboard linear actuator 25 is operated to impose a displacement v2 between the distal end of the second arm 213 bell crank 21 and the wing tip device 11, which also causes the wing tip device 11 to rotate away from the flight configuration F.

The control system 60 may be configurable to actuate the inboard linear actuator 23 and outboard linear actuator 25 simultaneously such that the displacements v1 and v2 are imposed simultaneously. The control system 60 may be configurable to actuate the inboard linear actuator 23 and outboard linear actuator 25 in sequence such that the displacements v1 and v2 are imposed sequentially; for example, one of the inboard or outboard linear actuators 23, 25 may be operated before the other. It will be understood that the wing tip device 11 can be moved from the ground configuration G to the flight configuration F by operating the outboard and inboard linear actuators 23, 25 in reverse.

Bending of the wing 3 caused by, for example, the aerodynamic loads on the wing 3 being reduced as the aircraft lands or by the aerodynamic or structural loads on the wing changing as the wing tip device 11 is moved towards the ground configuration G may introduce loads into the actuation system 20. Such loads, if overly constrained, would introduce undesirable stress concentrations into the actuation system 20 and the points at which the actuation system 20 connects with the fixed wing 5 and the wing tip device 11. A particular benefit of the embodiment described above is that the over-sized fulcrum hole 215 of the bell crank 21 reduces the constraint placed on the bell crank 21 by allowing it to translate to a limited degree with respect to the crank pin 27 during movement of the wing tip device 11 between the flight configuration F and the ground configuration G. In other embodiments of the invention, the relative dimensions of the fulcrum hole and the crank pin may be such that no substantial translation of the bell crank relative to the crank pin is permitted.

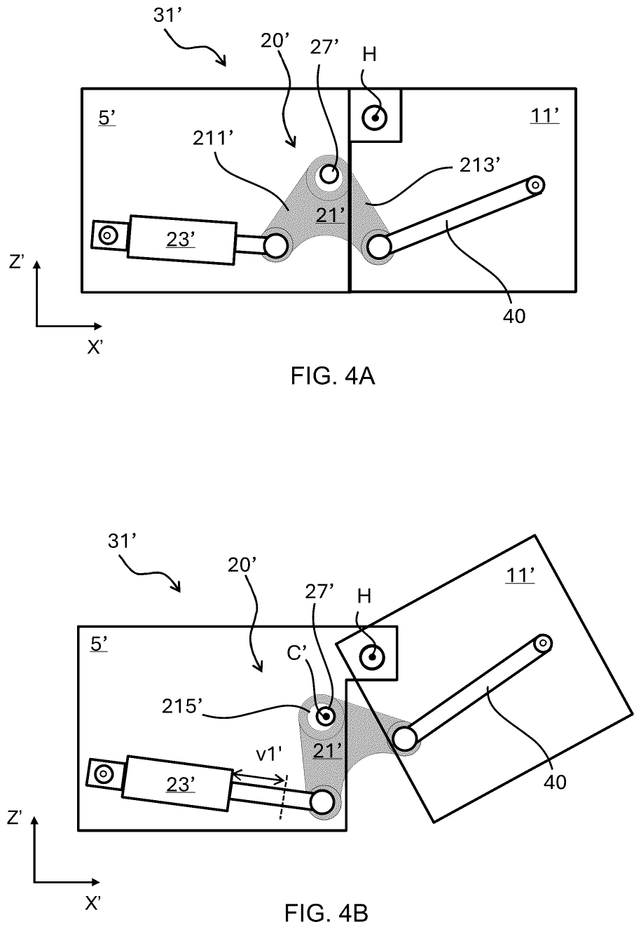

A schematic drawing of a wing assembly 31′ of an aircraft wing according to a second embodiment of the invention is shown FIGS. 4A-C. Similar to the wing assembly 31 of the aircraft 1 of the first embodiment of the invention, the wing assembly 31′ comprises a fixed wing 5′ and wing tip device 11′ which is moved between a ground configuration and the flight configuration by an actuation system 20′. The wing assembly 31′ of the second embodiment of the invention has several features in common with the wing assembly 31 of the first embodiment of the invention. The features of the wing assembly 31′ which are equivalent to those described above with respect to the wing assembly 31 have therefore been assigned the same reference numerals but suffixed with ′; for example, the wing assembly 31′ of the second embodiment of the invention has an inboard linear actuator 23′, whereas the wing assembly 31 of the first embodiment has an inboard linear actuator 23.

Similar to the wing assembly 31 of the first embodiment of the invention, the inboard linear actuator 23′ is connected between the first arm 211′ of the bell crank 21′ and the fixed wing 5′. The wing assembly 31′ of the second embodiment of the invention differs from that of the first embodiment of the invention primarily in that the actuation system 20′ comprises a pushrod 40 in place of an outboard linear actuator 25 connected between the second arm 213′ of the bell crank 21′ and the wing tip device 11′. The pushrod 40 comprises an elongate rod for transferring the actuation force provided by the inboard linear actuator 23′ to the wing tip device 11′. With reference to FIG. 4C, the pushrod 40 is mounted to the wing tip device 11′ via a fitting 41 which is mounted to a rib 111′ of the wing tip device 11′.

In order to move the wing tip device 11′ from the flight configuration F to the ground configuration G the inboard linear actuator 23′ is operated using a control system of the aircraft. Specifically, the inboard linear actuator 23′ is operated to displace the distal end of the first arm 211′ of the bell crank 21′ by a distance v1′, as shown in FIG. 4B, which causes the bell crank 21′ to rotate about the bell crank axis C′ and to push the pushrod 40 to move the wing tip device 11′ away from the flight configuration F. Again, it will be appreciated that the wing tip device 11′ can be moved from the ground configuration to the flight configuration by operating the inboard linear actuator 23′ in reverse. It will also be appreciated that the pushrod 40 behaves in the same manner as the outboard linear actuator 25 of the first embodiment of the invention in the event that the outboard linear actuator 25 is not actuated.

Again, in the second embodiment of the invention, the over-sized fulcrum hole 215′ of the bell crank 21′ reduces the constraint placed on the bell crank 21′ by allowing it to translate by a limited degree with respect to the crank pin 27′ during movement of the wing tip device 11′ between the flight configuration F and the ground configuration G.

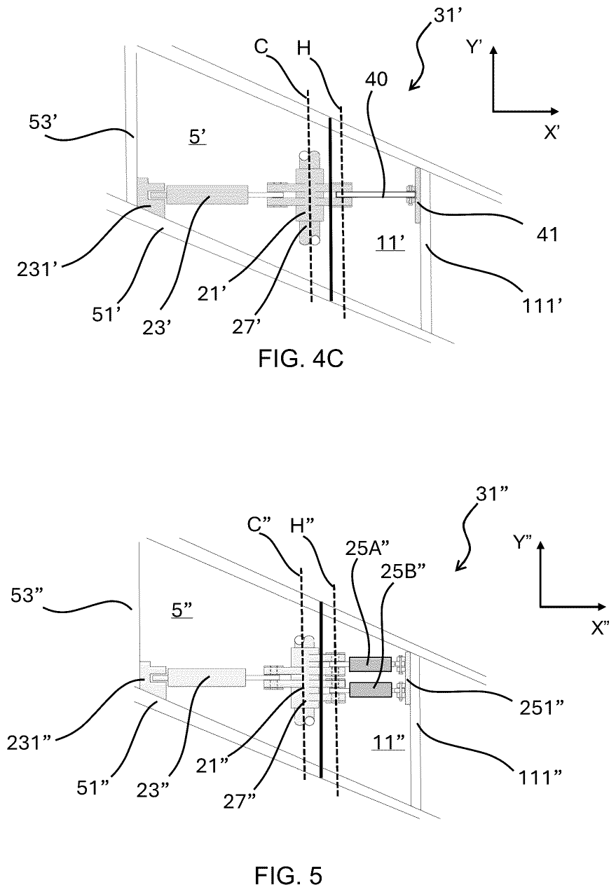

A schematic plan view of a wing assembly 31″ of an aircraft according to a third embodiment of the invention which is similar to the wing assembly 31 of the first embodiment of the invention is shown FIG. 5. The features of the wing assembly 31″ which are equivalent to those described above with respect to the wing assembly 31 have therefore been assigned the same reference numerals but suffixed with ″; for example, the wing assembly 31″ of the third embodiment of the invention has an inboard linear actuator 23″, whereas the wing assembly 31 of the first embodiment has an inboard linear actuator 23.

The wing assembly 31″ of the third embodiment of the invention differs from that of the first embodiment of the invention primarily in that the single outboard linear actuator 25 of the actuation system 20 has been replaced with a pair of outboard linear actuators 25A″, 25B″ which are arranged in parallel and which are configured to be operated in tandem when the wing tip device 11″ is moved between the flight configuration and the ground configuration. Such an arrangement may be beneficial where, for example, the space available within the wing tip device 11″ does not permit a single larger actuator to be used. Multiple smaller actuators can therefore be used to achieve the same actuation force as a single larger actuator.

Whilst the present invention has been described and illustrated with reference to particular embodiments, it will be appreciated by those of ordinary skill in the art that the invention lends itself to many different variations not specifically illustrated herein. For example, while in the embodiments of the invention described above the relative dimensions of the crank pin and the fulcrum hole are such that the crank pin is able to translate within the fulcrum hole, it should be understood that this feature is optional. In other embodiments of the invention there may be no substantial clearance between the crank pin and the fulcrum hole such that the bell crank is not able to translate with respect to the crank pin during movement of the wing tip device between the flight configuration and the ground configuration.

In the embodiments of the invention described above, the bell crank is rotatably mounted to the fixed wing. In other embodiments of the invention, the bell crank is instead rotatably mounted to the wing tip device, with a linear actuator being connected between the bell crank and the wing tip device. In such embodiments, either a pushrod or a linear actuator arrangement may be connected between the bell crank and the fixed wing. The skilled person will of course be aware of various suitable types of linear actuator. For example, a linear actuator may be provided by a linear hydraulic actuator, a roller screw actuator, or a ball screw actuator. In embodiments of the invention, a linear actuator may be provided by a geared rotary actuator and a pushrod, with the pushrod being connected between the geared rotary actuator and the bell crank.

In other embodiments of the invention, the bell crank may be formed with a pin which is rotatably mounted within a hole provided by the fixed wing or wing tip device. In such embodiments, the bell crank pin may or may not be dimensioned with respect to the hole to allow translation of the bell crank with respect to the hole during movement of the wing tip device between the flight configuration and the ground configuration.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

The term ‘or’ shall be interpreted as ‘and/or’ unless the context requires otherwise.

1. An aircraft wing assembly,
the aircraft wing assembly comprising a fixed wing and a wing tip device at the tip thereof, wherein the wing tip device is configurable between: (i) a flight configuration for use during flight and (ii) a ground configuration for use during ground-based operations, in which ground configuration the wing tip device is rotated away from the flight configuration about a hinge axis such that the span of the aircraft wing assembly is reduced, wherein:
the aircraft wing assembly further comprises a wing tip device actuation system comprising a bell crank and a first linear actuator; wherein
the bell crank is rotatably mounted to one of the fixed wing or wing tip device at a pivot point of the bell crank and is rotatable about a bell crank axis defined by the pivot point, the bell crank axis being offset from the hinge axis,
the bell crank is connected to the one of the fixed wing or the wing tip device on a first side of the pivot point by a linear actuator;
the bell crank is connected to the other one of the fixed wing or wing tip device on an opposite second side of the pivot point; and
the first linear actuator is operable to rotate the bell crank about the bell crank axis to thereby move the wing tip device about the hinge axis, between the flight configuration and the ground configuration.

2. An aircraft wing assembly according to claim 1, wherein the bell crank axis is offset from the hinge axis along a first direction, the first direction being perpendicular to the hinge axis.

3. An aircraft wing assembly according to claim 2, wherein the bell crank axis is offset from the hinge axis along a second direction, the second direction being perpendicular to the hinge axis and to the first direction.

4. An aircraft wing assembly according to claim 1, wherein the first linear actuator comprises at least two linear actuators arranged in parallel.

5. An aircraft wing assembly according to claim 1, wherein the first linear actuator is connected to the bell crank at a first end and to a rib of the aircraft wing assembly at an opposite second end.

6. An aircraft wing assembly according to claim 1, wherein the first linear actuator is connected to the bell crank at a first end and to a spar or a stringer of the aircraft wing assembly at an opposite second end.

7. An aircraft wing assembly according to claim 1, wherein the wing tip device actuation system further comprises a second linear actuator; the bell crank is connected to the other one of the fixed wing or wing tip device by the second linear actuator; and the second linear actuator is operable to impose a displacement between the bell crank and the other one of the fixed wing or wing tip device to thereby move the wing tip device between the flight configuration and the ground configuration.

8. An aircraft wing assembly according to claim 1, wherein the wing tip device actuation system further comprises pushrod, and the bell crank is connected to the other one of the fixed wing or wing tip device by the pushrod.

9. An aircraft wing assembly according to claim 1, wherein the bell crank is rotatably mounted to the one of the fixed wing or wing tip device at the pivot point of the bell crank via a male-female connector, the male-female connector having sufficient play to allow translation of the bell crank in a direction perpendicular to the bell crank axis to accommodate bending of the aircraft wing assembly during movement of the wing tip device between the flight configuration and the ground configuration.

10. An aircraft wing assembly according to claim 9, wherein the female part of the connector is dimensioned with respect to the male part to permit translation of the bell crank by up to ±4 millimetres in a direction perpendicular to the bell crank axis during movement of the wing tip device between the flight configuration and the ground configuration.

11. An aircraft wing assembly comprising a fixed wing, a wing tip device at the tip of the fixed wing, a pair of lever arms, and a linear actuator, wherein:
the wing tip device is movable with respect to the fixed wing between: (i) a flight configuration for use during flight and (ii) a ground configuration in which the wing tip device is rotated away from the flight configuration about a hinge axis such that the span of the aircraft wing assembly is reduced, wherein:
the pair of lever arms is pivotally mounted to the aircraft wing assembly at a pivot point of the pair of lever arms, the pair of lever arms being pivotable about a lever axis which is spaced apart from the hinge axis;
the linear actuator is connected between a first arm of the pair of lever arms and one of the fixed wing or wing tip device;
a second arm of the pair of lever arms is connected to the other one of the fixed wing or the wing tip device, the pivot point of the pair of lever arms being between at the joint between the first and second lever arms; and
the linear actuator is configured to displace the first arm of the pair of lever arms relative to the one of the fixed wing or wing tip device, to move the wing tip device about the hinge axis between the fight configuration and the ground configuration.

12. An aircraft wing assembly according to claim 11, wherein the hinge axis is parallel to the streamwise direction of the aircraft wing assembly.

13. An aircraft wing comprising the aircraft wing assembly of claim 11.

14. An aircraft comprising the aircraft wing of claim 13.

15. A method of moving the wing tip device of the aircraft wing assembly of claim 7 between the flight configuration and the ground configuration, the method comprising the steps of operating the first linear actuator to rotate the bell crank about the bell crank axis and operating the second linear actuator to displace the other one of the fixed wing or wing tip device with respect to the bell crank.

16. An aircraft wing assembly according to claim 1, wherein the hinge axis is parallel to the streamwise direction of the aircraft wing assembly.

17. An aircraft wing comprising the aircraft wing assembly of claim 1.

18. An aircraft comprising the aircraft wing of claim 17.
